(19) United States
(12) Patent Application Publication
(10) Pub. No.: US 2020/0067717 A1
(43) Pub. Date: Feb. 27, 2020

(54) AUTHENTICATION SYSTEM, AUTHENTICATION DEVICE, TERMINAL DEVICE, AUTHENTICATION METHOD, AND RECORDING MEDIUM

(71) Applicant: NEC Corporation, Minato-ku, Tokyo (JP)

(72) Inventor: Ryohei IKEYA, Tokyo (JP)

(73) Assignee: NEC Corporation, Minato-ku, Tokyo (JP)

(21) Appl. No.: 16/495,447

(22) PCT Filed: Mar. 13, 2018
(86) PCT No.: PCT/JP2018/009655

§ 371 Date: Sep. 19, 2019

(30) Foreign Application Priority Data
Mar. 22, 2017 (JP) 2017-055829

(51) Int. Cl. H04L 9/32; H04L 9/08; H04L 9/30

(52) U.S. Cl. CPC H04L 9/3271; H04L 9/30; H04L 9/0866

(57) ABSTRACT

Provided is an authentication device capable of maintaining confidentiality, availability, and integrity in a lifecycle of an encryption key. The authentication device includes: a key information generation unit that generates a public key and a generation rule of an encryption key, in response to a key issuance request including a plurality of pieces of specific information that are specific to a terminal device; an encryption key generation unit that generates the encryption key, based on the generation rule and the plurality of pieces of specific information; and an encryption unit that encrypts the public key with the encryption key, and generates an encrypted public key.

### TECHNICAL FIELD

The present invention relates to an authentication system, an authentication device, a terminal device, an authentication method, and a program.

### BACKGROUND ART

Client authentication is sometimes used when utilizing the Internet. In client authentication, a terminal device stores an electronic certificate generated based on an encryption technology, and verification of the electronic certificate is performed when connecting to an application such as Web service, whereby authentication is performed. As a system of performing the client authentication, for example, there is a system including: a storage server device that stores an encrypted confidential information file; a software server device that stores software for encrypting/decrypting confidential information; and a terminal device. In this system, the encryption/decryption software is downloaded to the terminal device, and the confidential information is encrypted/decrypted by using the software (refer to PTL 1). A related art for executing client authentication is also disclosed in PTL 2.

### CITATION LIST

### Patent Literature

[PTL 1] Japanese Unexamined Patent Application Publication No. 2002-236618

[PTL 2] Japanese Unexamined Patent Application Publication No. 2004-208088

### SUMMARY OF INVENTION

### Technical Problem

However, in the technology described in PTL 1, an encryption key included in the confidential information is stored in hardware of the terminal device, and the encryption key is encrypted only once after the encryption key is initially shipped. Therefore, there is a problem that a lifecycle from generation to discarding of the encryption key cannot be maintained, and confidentiality, availability, and integrity that are security elements cannot be maintained.

The present invention has been made in order to solve the above-described problem. An object of the present invention is to provide an authentication system, an authentication device, a terminal device, an authentication method, and a program being capable of maintaining confidentiality, availability, and integrity in a lifecycle of an encryption key.

### Solution to Problem

A first aspect of the present invention is an authentication system includes:

a key information generation unit that generates a public key and a generation rule of an encryption key, in response to a key issuance request including a plurality of pieces of specific information that are specific to a terminal device;

an encryption key generation unit that generates the encryption key, based on the generation rule and the plurality of pieces of specific information; and

an encryption unit that encrypts the public key with the encryption key, and generates an encrypted public key.

A second aspect of the present invention is an authentication device includes a key information generation unit that generates a public key and a generation rule of an encryption key, in response to a key issuance request including a plurality of pieces of specific information that are specific to a terminal device.

A third aspect of the present invention is a terminal device includes:

an issuance requesting unit that generates a key issuance request including a plurality of pieces of specific information that are specific to a terminal device;

an encryption key generation unit that generates the encryption key, based on a public key in response to the key issuance request, a generation rule of an encryption key, and the plurality of pieces of specific information; and

an encryption unit that encrypts the public key with the encryption key, and generates an encrypted public key.

A fourth aspect of the present invention is an authentication method includes,

by a computer of an authentication device,

generating a public key and a generation rule of an encryption key, in response to a key issuance request including a plurality of pieces of specific information that are specific to a terminal device.

A fifth aspect of the present invention is an authentication method comprising,

by a computer of an authentication device,

generating a public key and a generation rule of an encryption key, in response to a key issuance request including a plurality of pieces of specific information that are specific to a terminal device.

A sixth aspect of the present invention is a program for causing a computer of an authentication device to execute a step of

generating a public key and a generation rule of an encryption key, in response to a key issuance request including a plurality of pieces of specific information that are specific to a terminal device.

A seventh aspect of the present invention is a program for causing a computer of a terminal device to execute:

a step of generating a key issuance request including a plurality of pieces of specific information that are specific to the terminal device;

a step of generating the encryption key, based on a public key in response to the key issuance request, a generation rule of an encryption key, and the plurality of pieces of specific information; and

a step of encrypting the public key with the encryption key, and generating an encrypted public key.

Those program may be stored in a recording medium.

### Advantageous Effects of Invention

According to one aspect of the present invention, an authentication device capable of maintaining confidentiality, availability, and integrity in a lifecycle of an encryption key can be provided.

### BRIEF DESCRIPTION OF DRAWINGS

FIG. 1 is a system configuration diagram illustrating one example of a configuration of an authentication system according to a first example embodiment.

FIG. 2 is a schematic block diagram illustrating one example of a hardware configuration of a terminal device according to the first example embodiment.

FIG. 3 is a schematic block diagram illustrating one example of a software configuration of the terminal device according to the first example embodiment.

FIG. 4 is an explanatory view illustrating one example of a data structure of key information stored in the terminal device according to the first example embodiment.

FIG. 5 is a schematic block diagram illustrating another example of the software configuration of the terminal device according to the first example embodiment.

FIG. 6 is a schematic block diagram illustrating one example of a hardware configuration of an authentication device according to the first example embodiment.

FIG. 7 is a schematic block diagram illustrating one example of a software configuration of the authentication device according to the first example embodiment.

FIG. 8 is an explanatory view illustrating one example of a data structure between a key information table stored in the authentication device according to the first example embodiment and specific information table.

FIG. 9 is a schematic block diagram illustrating another example of the software configuration of the authentication device according to the first example embodiment.

FIG. 10 is a sequence diagram illustrating one example of key issuance processing according to the first example embodiment.

FIG. 11 is a sequence diagram illustrating another example of authentication processing according to the first example embodiment.

### EXAMPLE EMBODIMENT

Hereinafter, example embodiments of the present invention will be described with reference to the drawings.

### First Example Embodiment

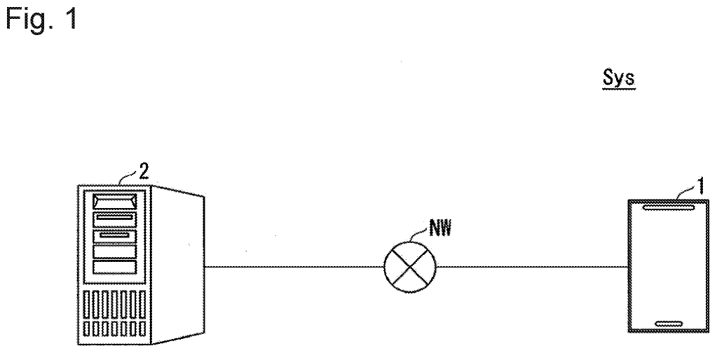

FIG. 1 is a system configuration diagram illustrating one example of a configuration of authentication system Sys according to a first example embodiment.

Authentication system “Sys” includes terminal device 1 and authentication device 2. Terminal device 1 and authentication device 2 are connected via network “NW”.

Terminal device 1 is an electronic device such as a smartphone, a tablet Personal Computer (PC), or a laptop PC used by a user, for example. Terminal device 1 requests key issuance to authentication device 2. When receiving a plurality of pieces of information including key information, and an encryption key generation rule from authentication device 2, terminal device 1 also generates an encryption key, based on the encryption key generation rule. In addition, terminal device 1 encrypts key information with the generated encryption key, and stores the encrypted key information.

Authentication device 2 generates key information when key issuance is requested from terminal device 1. Here, the key information denotes a public key, for example. Also, authentication device 2 generates a challenge when receiving an authentication request from terminal device 1, and transmits a response including the generated challenge and the encryption key generation rule to terminal device 1. Here, the challenge is a numeral string composed of random numbers generated by a random number generator and the like, for example. In addition, authentication device 2 decrypts, when receiving a response authentication request generated by terminal device 1, a response included in the response authentication request according to key information, and performs authentication of terminal device 1 by a terminal identifier associated with the key information stored in authentication device 2.

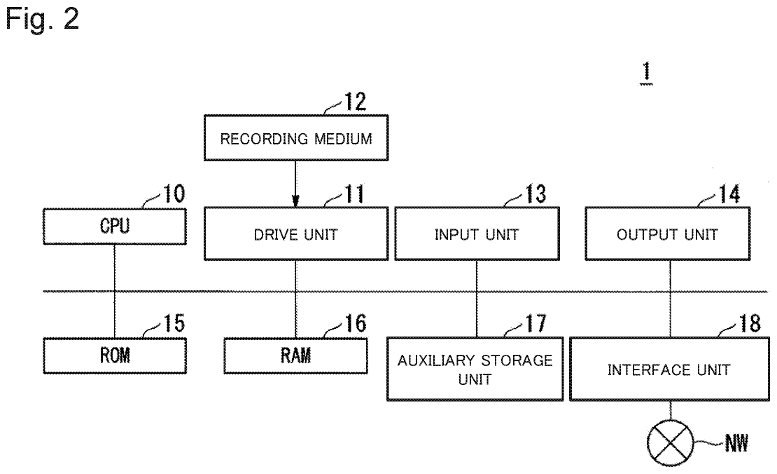

FIG. 2 is a schematic block diagram illustrating one example of a hardware configuration of terminal device 1 according to the first example embodiment.

Terminal device 1 includes CPU 10, drive unit 11, storage medium 12, input unit 13, output unit 14, Read Only Memory (ROM) 15, Random Access Memory (RAM) 16, auxiliary storage unit 17, and interface unit 18. Central Processing Unit (CPU) 10, drive unit 11, input unit 13, output unit 14, ROM 15, RAM 16, auxiliary storage unit 17, interface unit 18 are interconnected via a bus.

CPU 10 reads out and executes a program stored in auxiliary storage unit 17 and various data stored in ROM 15 and RAM 16, and controls terminal device 1. Also, CPU 10 reads out and executes various data stored in storage medium 12 via drive unit 11, and controls terminal device 1. Storage medium 12 is a portable storage medium such as a magneto-optical disk, a flexible disk, or a flash memory, and stores various data.

Drive unit 11 is a readout device of storage medium 12 such as an optical disk drive or a flexible disk drive.

Input unit 13 is an input device such as a mouse, a keyboard, or a touch panel.

Output unit 14 is an output device such as a display unit or a speaker.

ROM 15 and RAM 16 store various data.

Auxiliary storage unit 17 is a hard disk drive, a flash memory, or the like, and stores a program for operating functional parts of terminal device 1 and various data.

Interface unit 18 has a communication interface, and is connected to network NW by a wired or wireless channel.

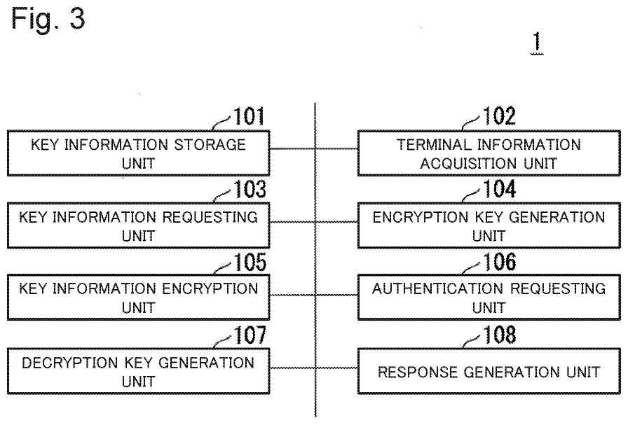

Key information storage unit 101 in a software configuration of terminal device 1 in FIG. 3, which will be described later, relates to storage medium 12 in FIG. 2, for example. Terminal information acquisition unit 102, key information requesting unit 103, encryption key generation unit 104, key information encryption unit 105, authentication requesting unit 106, decryption key generation unit 107, and response generation unit 108 in FIG. 3 relate to CPU 10 in FIG. 2.

FIG. 3 is a schematic block diagram illustrating one example of a software configuration of terminal device 1 according to the first example embodiment.

Terminal device 1 includes key information storage unit 101, terminal information acquisition unit 102, key information requesting unit 103, encryption key generation unit 104, key information encryption unit 105, authentication requesting unit 106, decryption key generation unit 107, and response generation unit 108.

### <Key Issuance Processing>

First, key issuance processing will be described.

Key information storage unit 101 stores key information encrypted with an encryption key. Here, the key information denotes a public key, for example.

Terminal information acquisition unit 102 acquires specific information that is specific to terminal device 1. The information specific to terminal device 1 is information including at least either specific information by device or specific information by model, such as a screen size, an individual identification number of terminal device 1, a corresponding language, a corresponding Operating System (OS), a model name, a storage capacity, a manufacturing number of terminal device 1, a model number, a modem firmware number, a telephone number, or performance values of CPU and the like, for example. Terminal information acquisition unit 102 collects and acquires, from the inside of terminal device 1, a plurality of pieces of specific information that can be acquired by an application of a browser and the like, for example.

Key information requesting unit 103 transmits a key information issuance request (also referred to as key issuance request) to authentication device 2 according to a user operation. The key issuance request includes specific information acquired by terminal information acquisition unit 102.

Encryption key generation unit 104 generates an encryption key, based on key information received from authentication device 2 as a response to the key issuance request. The key information received from authentication device 2 includes: an encryption key generation rule for generating an encryption key, which is generated by authentication device 2; public key information; and a terminal identifier. Encryption key generation unit 104 generates an encryption key for encrypting a public key, in accordance with the encryption key generation rule.

Key information encryption unit 105 encrypts, by the encryption key generated by encryption key generation unit 104, public key information included in the key information received from authentication device 2. Key information encryption unit 105 stores the encrypted public key information in key information storage unit 101.

### <Authentication Processing>

Next, authentication processing will be described.

Authentication requesting unit 106 transmits an authentication request to authentication device 2 according to a user operation.

Decryption key generation unit 107 generates a decryption key, based on a response received from authentication device 2 as a response to the authentication request. The response received from authentication device 2 includes a challenge and an encryption key generation rule. Decryption key generation unit 107 generates, in accordance with the encryption key generation rule, a decryption key for decrypting the encrypted key information stored in key information storage unit 101.

Response generation unit 108 decrypts, by the decryption key generated by decryption key generation unit 107, the encrypted key information stored in key information storage unit 101. Response generation unit 108 encrypts, by using the decrypted key information, a challenge included in the response received from authentication device 2, and generates a response. Here, the response includes a terminal identifier. Response generation unit 108 transmits the generated response to authentication device 2 as a response authentication request.

Response generation unit 108 also receives an authentication result from authentication device 2 as a response to the response authentication request.

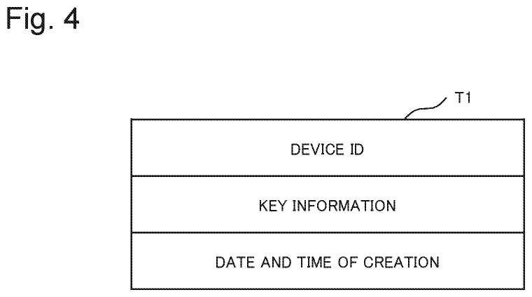

FIG. 4 is an explanatory view illustrating one example of a data structure of the key information stored in terminal device 1 according to the first example embodiment.

The illustrated example is a data structure example of key information T1 stored in key information storage unit 101.

Key information T1 has a data structure in which a device IDentifier (ID) representing the terminal identifier generated by authentication device 2, the key information (public key) generated by authentication device 2, and date and time of creation when the key information is generated by authentication device 2 are associated with one another, for example. The key information having the data structure is stored in key information storage unit 101 in an encrypted state.

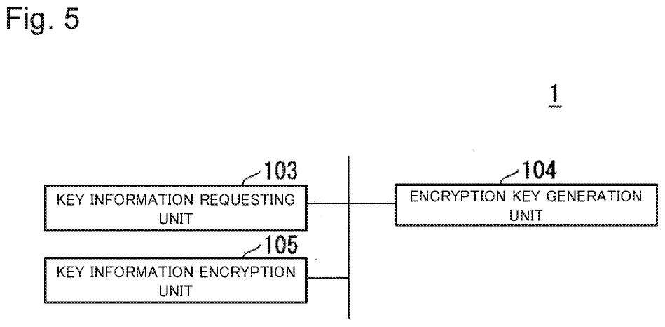

FIG. 5 is a schematic block diagram illustrating another example of a software configuration of terminal device 1 according to the first example embodiment.

As illustrated, terminal device 1 may include at least key information requesting unit 103, encryption key generation unit 104, and key information encryption unit 105.

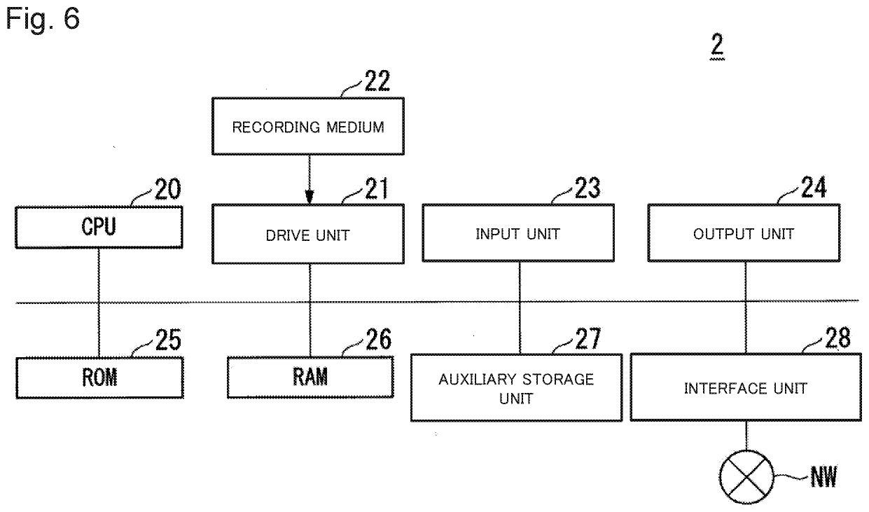

FIG. 6 is a schematic block diagram illustrating one example of a hardware configuration of authentication device 2 according to the first example embodiment.

Authentication device 2 includes CPU 20, drive unit 21, storage medium 22, input unit 23, output unit 24, ROM 25, RAM 26, auxiliary storage unit 27, and interface unit 28. CPU 20, drive unit 21, input unit 23, output unit 24, ROM 25, RAM 26, auxiliary storage unit 27, and interface unit 28 are interconnected via a bus.

CPU 20 reads out and executes a program stored in auxiliary storage unit 27 and various data stored in ROM 25 and RAM 26, and controls authentication device 2. Also, CPU 20 reads out and executes various data stored in storage medium 22 via drive unit 21, and controls authentication device 2. Storage medium 22 is a portable storage medium such as a magneto-optical disk, a flexible disk, or a flash memory, and stores various data.

Drive unit 21 is a readout device of storage medium 22 such as an optical disk drive or a flexible disk drive.

Input unit 23 is an input device such as a mouse, a keyboard, or a touch panel.

Output unit 24 is an output device such as a display unit or a speaker.

ROM 25 and RAM 26 store various data.

Auxiliary storage unit 27 is a hard disk drive, a flash memory, or the like, and stores a program for operating each functional unit of authentication device 2 and various data.

Interface unit 28 has a communication interface, and is connected to network NW by a wired or wireless channel.

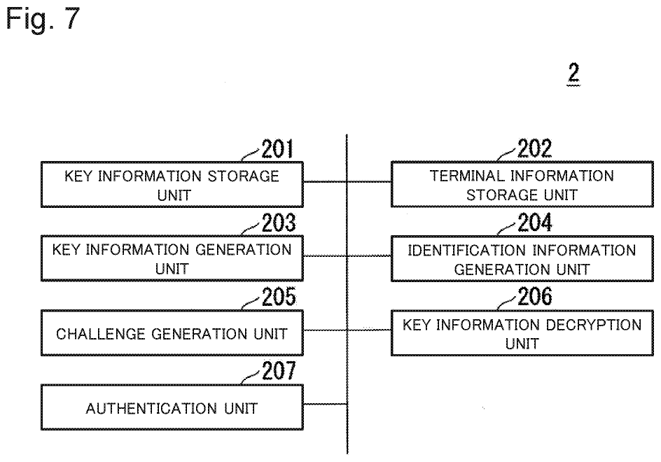

Key information storage unit 201 and terminal information storage unit 202 in a software configuration of authentication device 2 in FIG. 7, which will be described later, relate to storage medium 22 in FIG. 6, for example. Key information generation unit 203, identification information generation unit 204, challenge generation unit 205, key information decryption unit 206, and authentication unit 207 in FIG. 7 relate to CPU 20 in FIG. 6.

FIG. 7 is a schematic block diagram illustrating one example of a software configuration of authentication device 2 according to the first example embodiment.

Authentication device 2 includes key information storage unit 201, terminal information storage unit 202, key information generation unit 203, identification information generation unit 204, challenge generation unit 205, key information decryption unit 206, and authentication unit 207.

### <Key Issuance Processing>

First, key issuance processing will be described.

Key information storage unit 201 stores generated key information, based on a key issuance request including specific information received from terminal device 1. Here, the example embodiment describes a case where authentication device 2 instructs terminal device 1 by a parameter of specific information of terminal device 1 included in the key issuance request. Note that, for the parameter of the specific information, after parameters that can be collected in terminal device 1 are acquired and transmitted to authentication device 2, one or a plurality of parameters of the specific information may be selected from among the parameters received by authentication device 2.

Terminal information storage unit 202 stores the specific information of terminal device 1 and identification information of terminal device 1 generated by authentication device 2 in association with each other.

Key information generation unit 203 generates key information, based on the key issuance request received from terminal device 1. Key information generation unit 203 stores the generated key information in key information storage unit 201.

Identification information generation unit 204 generates, when receiving the key issuance request including the specific information of terminal device 1 from terminal device 1, a terminal identifier that identifies terminal device 1, based on the received specific information of terminal device 1. Key information generation unit 203 stores the generated terminal identifier and the specific information of terminal device 1 relating to the terminal identifier in terminal storage unit 202, in association with each other.

Identification information generation unit 204 also generates, based on the specific information, an encryption key generation rule relating to terminal device 1. Specifically, identification information generation unit 204 generates, among the specific information of terminal device 1, for example, an encryption key generation rule, such as hashing after implementing logical operation such as exclusive OR between a first parameter of specific information and a third parameter of specific information.

Identification information generation unit 204 transmits the generated key information to terminal device 1. The key information to be transmitted to terminal device 1 includes: the encryption key generation rule generated by identification information generation unit 204; and the terminal identifier generated by identification information generation unit 204.

### <Authentication Processing>

Next, authentication processing will be described.

Challenge generation unit 205 generates a challenge when receiving an authentication request from terminal device 1. The authentication request includes a terminal identifier of terminal device 1. Challenge generation unit 205 also generates an encryption key generation rule by referring to the specific information relating to the terminal identifier of terminal device 1, which is stored in terminal information storage unit 202. Challenge generation unit 205 transmits, to terminal device 1, a response including the generated challenge and encryption key generation rule.

Key information decryption unit 206 acquires, when receiving a response authentication request, the terminal identifier of terminal device 1 included in a response, by referring to the key information stored in key information storage unit 201 and decrypting the response according to the key information.

Authentication unit 207 determines whether or not terminal device 1 can be authenticated, based on the terminal identifier acquired by decrypting the response by key information decryption unit 206, by referring to the specific information relating to the terminal identifier stored in terminal information storage unit 202. Specifically, authentication unit 207 determines whether or not terminal device 1 can be authenticated, depending on whether or not key information decryption unit 206 can acquire the terminal identifier by decrypting the response. In addition, when the terminal identifier can be acquired, authentication unit 206 determines whether or not terminal device 1 can be authenticated, depending on whether or not the related terminal identifier is stored, by referring to terminal information storage unit 202. Authentication unit 207 transmits an authentication result to terminal device 1.

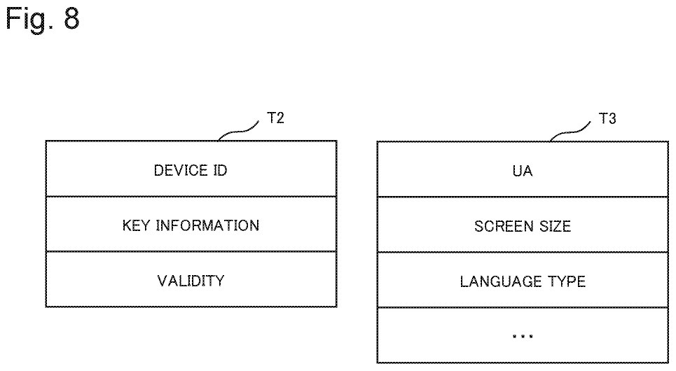

FIG. 8 is an explanatory view illustrating one example of a data structure between a key information table stored in the authentication device according to the first example embodiment and a specific information table.

The illustrated example is a data structure example of key information table T2 stored in key information storage unit 201.

Key information table T2 is, for example, a table having a data structure in which a device ID representing the terminal identifier of terminal device 1 generated by identification information generation unit 204, key information (public key) generated by key information generation unit 203, and validity of the key information are associated with one another.

The illustrated example is also a data structure example of specific information table T3 stored in terminal information storage unit 202.

Specific information table T3 is prepared for each terminal identifier. The specific information of terminal device 1 is a table having a data structure in which at least User Agent (UA) representing a type (model name) of terminal device 1, a version of OS, a type of application of browser and the like, a size of a display unit of terminal device 1, and a language type of terminal device 1 are associated with one another, for example.

Authentication device 2 may specify specific information table T3 by specifying a parameter independent of each terminal device. In other words, the data structure of specific information table T3 may be a data structure different depending on each terminal identifier.

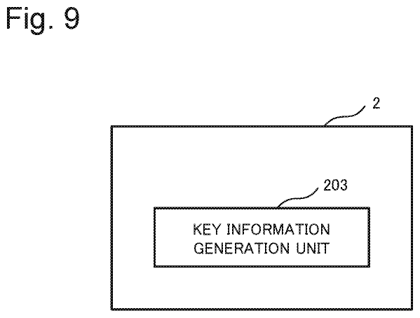

FIG. 9 is a schematic block diagram illustrating another example of the software configuration of authentication device 2 according to the first example embodiment.

As illustrated, authentication device 2 may include at least key information generation unit 203.

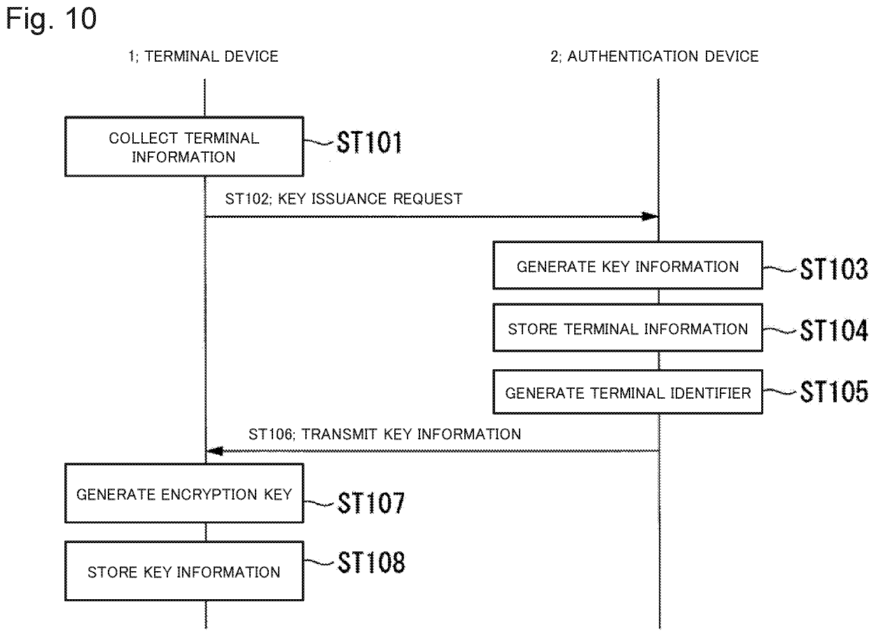

FIG. 10 is a sequence diagram illustrating one example of key issuance processing according to the first example embodiment.

In step ST101, terminal information acquisition unit 102 acquires the specific information of terminal device 1.

In step ST102, key information requesting unit 103 transmits, to authentication device 2, a key issuance request including the specific information of terminal device 1 acquired by terminal information acquisition unit 102.

In step ST103, key information generation unit 203 generates key information, based on the key issuance request received from terminal device 1. Key information generation unit 203 stores the generated key information in key information storage unit 201.

In step ST104, identification information generation unit 204 stores the specific information of terminal device 1 included in the key issuance request, in terminal information storage unit 202.

In step ST105, identification information generation unit 204 generates the terminal identifier that identifies terminal device 1, based on the specific information of terminal device 1 included in the key issuance request. Key information generation unit 204 stores the generated terminal identifier and the specific information of terminal device 1 relating to the terminal identifier in terminal information storage unit 202, in association with each other. Identification information generation unit 204 also generates, based on the specific information, an encryption key generation rule relating to terminal device 1.

In step ST106, identification information generation unit 204 transmits the generated key information to terminal device 1. The key information to be transmitted to terminal device 1 includes: the encryption key generation rule generated by identification information generation unit 204; and the terminal identifier generated by identification information generation unit 204.

In step ST107, encryption key generation unit 104 generates an encryption key, based on the key information received from authentication device 2 as a response to the key issuance request.

In step ST108, key information encryption unit 105 encrypts, by the encryption key generated by encryption key generation unit 104, information of a public key included in the key information received from authentication device 2. Key information encryption unit 105 stores the encrypted information of the public key in key information storage unit 101.

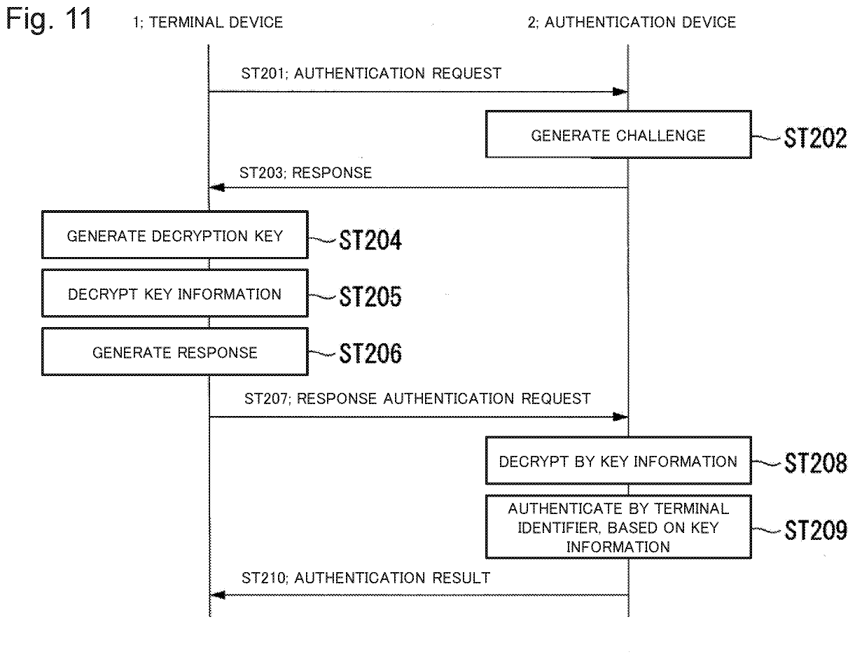

FIG. 11 is a sequence diagram illustrating another example of authentication processing according to the first example embodiment.

In step ST201, authentication requesting unit 106 transmits an authentication request to authentication unit 2, according to a user operation.

In step ST202, challenge generation unit 205 generates a challenge when receiving an authentication request from terminal device 1. The authentication request includes the terminal identifier of terminal device 1. Challenge generation unit 205 also generates an encryption key generation rule, by referring to the specific information relating to the terminal identifier of terminal device 1, stored in terminal information storage unit 202.

In step ST203, challenge generation unit 205 transmits, to terminal device 1, a response including the generated challenge and encryption key generation rule.

In step ST204, decryption key generation unit 107 generates a decryption key, based on a response received from authentication device 2 as a response to an authentication request. Specifically, decryption key generation unit 107 generates, in accordance with the encryption key generation rule, a decryption key for decrypting the encrypted key information stored in key information storage unit 101.

In step ST205, response generation unit 108 decrypts, by the decryption key generated by decryption key generation unit 107, the encrypted key information stored in key information storage unit 101.

In step ST206, response generation unit 108 encrypts, by using the decrypted key information, the challenge included in the response received from authentication device 2, and generates a response.

In step ST207, response generation unit 108 transmits the generated response, as a response authentication request, to authentication device 2.

In step ST208, key information decryption unit 206 acquires, when receiving a response authentication request, the terminal identifier of terminal device 1 included in a response, by referring to the key information stored in key information storage unit 201 and decrypting the response according to the key information.

In step ST209, authentication unit 207 determines whether or not terminal device 1 can be authenticated, based on the terminal identifier acquired by decrypting the response by key information decryption unit 206, by referring to the specific information relating to the terminal identifier stored in terminal information storage unit 202.

In step ST210, authentication unit 207 transmits an authentication result to terminal device 1.

Thus, according to the first example embodiment, authentication system Sys includes: key information generation unit 203 that generates a public key and a generation rule of an encryption key, in response to a key issuance request including a plurality of pieces of specific information that are specific to terminal device 1; encryption key generation unit 104 that generates an encryption key, based on the generation rule and the plurality of pieces of specific information; and an encryption unit (key information encryption unit 105) that generates an encrypted public key by encrypting the public key with the encryption key.

With this structure, an encryption key and a public key can be safely managed, and therefore, confidentiality, availability, and integrity of information security can be maintained. Also, an encryption key generation rule is dynamically determined by authentication device 2, and an encryption key can be generated according to any combination of a plurality of parameters of specific information, and therefore, a risk of leak of the encryption key can be reduced. In addition, since the key information stored in terminal device 1 is encrypted, and terminal device 1 does not store an encryption key for decryption, safety can be enhanced. Further, which of the plurality of parameters of specific information is used cannot be identified without referring to the encryption generation rule, and therefore, strong security can be formed.

Note that, while one example in a case where authentication device 2 executes generation of key information has been described, after key information is generated in terminal device 1, authentication device 2 may store the key information.

Further, when the specific information of terminal device 1 is changed, processing may be newly executed from key processing.

Note that authentication device 2 may serially or periodically change generation of an encryption key generation rule or may use the same encryption key generation rule. Strong security can be thereby formed. In this case, authentication device 2 transmits, to terminal device 1, a new encryption generation rule after being changed, and the strong security can be thereby achieved.

Note that authentication device 2 may set a separate validity for each of the key information and the encryption key generation rule.

Note that a program operated by terminal device 1 or authentication device 2 in one aspect of the present invention may be a program that controls CPU and the like (computer-functioning program) in such a way as to achieve the functions presented in the above-described example embodiments or modified examples relating to one aspect of the present invention. The information handled by these devices is then temporarily accumulated in RAM during the processing, and is thereafter stored in various ROMs such as a flash ROM or in Hard Disk Drive (HDD), and readout and correction/writing are performed by CPU as required.

Note that a part of terminal device 1 and authentication device 2 in the above-described example embodiments or modified examples may be implemented by a computer. In that case, a part of these devices may be implemented by recording a program for implementing this control function in a computer readable recording medium, and causing a computer system to read and execute the program recorded in this recording medium.

Note that the “computer system” as used herein is a computer system built in terminal device 1 or authentication device 2, and includes OS or hardware such as peripheral(s). The “computer-readable recording medium” also denotes a portable medium such as a flexible disk, a magneto-optical disk, a ROM, or a Compact Disc (CD)-ROM, or a storage device such as a hard disk built in a computer system.

Further, the “computer-readable recording medium” may include: dynamically storing a program for a short time, as with a communication line in a case of transmitting a program via a network such as the Internet or a communication line such as a telephone line; or storing a program for a predetermined period of time, as with a volatile memory inside a computer system that is a server or a client in that case. Furthermore, the above-described program may be for implementing a part of the aforementioned functions or the aforementioned functions may be further implementable in combination with a program recorded in a computer system.

Also, a part or all of terminal device 1 and authentication device 2 in the above-described example embodiments or modified examples may be implemented as a Large-Scale Integrated circuit (LSI) that is typically an integrated circuit or may be implemented as a chip set. In addition, each of the functional blocks of terminal device 1 and authentication device 2 in the above-described example embodiments and modified examples may be individually chipped or a part or all of these devices may be integrated and chipped. Further, a technology of implementing an integrated circuit may be implemented by a dedicated circuit and/or a general-purpose processor without being limitative to LSI. Furthermore, when a technology of implementing an integrated circuit substituted for LSI is introduced with the progress of semiconductor technology, it is possible to use the integrated circuit implemented by the technology as well.

While each of the example embodiments and modified examples has been described in detail as one aspect of the present invention with reference to the drawings, a specific configuration is not limited to the example embodiments and modified examples. A design change and the like that do not deviate from the spirit of the present invention are included as well. Various modifications can occur to one aspect of the present invention within the scope set forth in the claims. An example embodiment obtained by appropriately combining technical means respectively disclosed in different example embodiments is included in the technical scope of the present invention as well. In addition, a configuration obtained by substituting the elements described in the example embodiments and modified examples, the elements attaining similar advantageous effects, is included as well.

This application claims priority from Japanese Unexamined Patent Application No. 2017-055829 filed on Mar. 22, 2017, the disclosure of which is incorporated herein in its entirety by reference.

### REFERENCE SIGNS LIST

Sys Authentication system
1 Terminal device
10 CPU
11 Drive unit
12 Storage medium
13 Input unit
14 Output unit
15 ROM
16 RAM
17 Auxiliary storage unit
18 Interface unit
101 Key information storage unit
102 Terminal information acquisition unit
103 Key information requesting unit
104 Encryption key generation unit
105 Key information encryption unit
106 Authentication requesting unit
107 Decryption key generation unit
108 Response generation unit
2 Authentication device
20 CPU
21 Drive unit
22 Storage medium
23 Input unit
24 Output unit
25 ROM
26 RAM
27 Auxiliary storage unit
28 Interface unit

What is claimed is:

1. An authentication system comprising:
a processor; and
a memory having stored therein computer instructions, wherein
the processor executes the instructions to:
generate a public key and a generation rule of an encryption key, in response to a key issuance request including a plurality of pieces of specific information that are specific to a terminal device;
generate the encryption key, based on the generation rule and the plurality of pieces of specific information; and
encrypt the public key with the encryption key, and generate an encrypted public key.

2. The authentication system according to claim 1, wherein
the generating the public key and the generation rule further generates identification information that identifies the terminal device, and the processor further execute instructions to:
generate a challenge, based on an authentication request including the identification information; and
generate a composite key, based on the challenge and the generation rule.

3. The authentication system according to claim 2, the processor further execute instructions to:
decrypt the encrypted public key with a decryption key; and
encrypt the challenge with the encryption key and generate an encrypted challenge, and generate a response authentication request including the encrypted challenge and the identification information.

4. The authentication system according to claim 3, the processor further executes the instructions to
decrypt the encrypted challenge with the public key, and authenticate the terminal device by the identification information associated with the public key.

5-6. (canceled)

7. An authentication method comprising,
by a computer of an authentication device,
generating a public key and a generation rule of an encryption key, in response to a key issuance request including a plurality of pieces of specific information that are specific to a terminal device.

8. An authentication method comprising:
by a computer of a terminal device,
generating a key issuance request including a plurality of pieces of specific information that are specific to the terminal device;
generating the encryption key, based on a public key in response to the key issuance request, a generation rule of an encryption key, and the plurality of pieces of specific information; and
encrypting the public key with the encryption key and generating an encrypted public key.

9-10. (canceled)
